(19) United States
(12) Patent Application Publication
(10) Pub. No.: US 2012/0140841 A1
(43) Pub. Date: Jun. 7, 2012

(54) BROADCAST CONTROLLING APPARATUS AND METHOD FOR CHANGING TRANSMISSION FREQUENCY IN DIGITAL BROADCASTING

(75) Inventor: Sung-Woong CHOI, Daejeon (KR)

(73) Assignee: Electronics and Telecommunications Research Institute, Daejeon (KR)

(21) Appl. No.: 13/175,466

(22) Filed: Jul. 1, 2011

(30) Foreign Application Priority Data
Dec. 7, 2010 (KR) 10-2010-0124016

(51) Int. Cl. H04L 27/00

(52) U.S. Cl. 375/295

(57) ABSTRACT

Provided is a broadcast controlling apparatus and method for changing a TX frequency in digital broadcasting. The broadcast controlling apparatus includes a broadcast controlling unit and a first broadcast signal transmitting unit. The broadcast controlling unit is configured to divide a data rate of an RF channel, while changing a TX frequency of a second RF channel, and allocate a first program provided through the RF channel and a second program provided through the second RF channel. The first broadcast signal transmitting unit is configured to process the first and second programs through the RF channel under the control of the broadcast controlling unit and digital-broadcast the resulting programs.

### CROSS-REFERENCE TO RELATED APPLICATIONS

The present application claims priority of Korean Patent Application No. 10-2010-0124016, filed on Dec. 7, 2010, which is incorporated herein by reference in its entirety.

### BACKGROUND OF THE INVENTION

1. Field of the Invention

Exemplary embodiments of the present invention relate to a broadcast controlling apparatus and method for changing a transmission (TX) frequency in digital broadcasting; and, more particularly, to a broadcast controlling apparatus and method for changing a TX frequency in digital broadcasting, which is to continuously provide a broadcast service (i.e., a program) allocated to a TX frequency according to a TX frequency change of another radio frequency (RF) channel and to continuously provide a broadcast service through a changed TX frequency, by multicasting an original program provided through an RF channel and a program provided through another RF channel, when changing a TX frequency of another RF channel in a digital broadcasting station.

2. Description of Related Art

At present, world-wide countries are switching analog broadcast (i.e., analog TV broadcast) to digital broadcast (i.e., digital TV broadcast). Due the frequency efficiency increase of digital technology, some of the broadcast frequencies allocated to digital broadcast will be reserved as free frequencies.

Korea is executing analog broadcast and digital broadcast simultaneously, and will terminate analog broadcast in 2012 upon completion of digital switchover.

However, the frequency of a digital broadcast channel for simultaneous broadcast is using a free frequency that will be reserved when executing digital broadcast in an overall manner.

Specifically, when executing digital broadcast in an overall manner, a frequency band of the digital broadcast is set to a UHF band of channels 14 to 51 (i.e., 470 MHz˜698 MHz) according to ‘Digital TV Channel Switchover Plan’ determined by the Korea Communications Commission in 2008. Herein, due to lack of frequencies, digital broadcast channels for simultaneous broadcast temporarily use channels 52 to 69 (i.e., 698 MHz˜806 MHz) corresponding to free frequencies that will be reserved when executing digital broadcast in an overall manner. That is, the frequencies of digital broadcast channels temporarily use channels 52 to 69 corresponding to the free frequencies during the simultaneous broadcast period, and TX frequencies are to be changed to a frequency band of channels 14 to 51 upon termination of analog broadcast. This means that more than about 800 stations among the digital broadcasting stations operated in the simultaneous broadcast period must change channels by changing TX frequencies.

This channel change is difficult to perform simultaneously in all broadcasting stations within a short period, and a broadcast service may have to be interrupted when changing a TX frequency. That is, when changing a TX frequency, a digital broadcasting station may have to replace or change a channel filter with a limited frequency bandwidth of 6 MHz, a cable whose phase is changed due to a frequency change, and a power divider in a TX antenna. To this end, the digital broadcasting station may have to replace or change facilities or equipments according to a digital TX frequency change through a complex process during a long period.

What is therefore required is a scheme for providing a broadcast service without interruption during a TX frequency change period in order to adapt to a broadcast environment where digital broadcast is executed in an overall manner.

### SUMMARY OF THE INVENTION

An embodiment of the present invention is directed to a scheme for replacing facilities and equipments without interruption of a broadcast service provided through a conventional free frequency, when switching analog broadcast to digital broadcast in an overall manner.

Another embodiment of the present invention is directed to a broadcast controlling apparatus and method for changing a TX frequency in digital broadcasting, which is to continuously provide a broadcast service (i.e., a program) allocated to a TX frequency according to a TX frequency change of another RF channel and to continuously provide a broadcast service through a changed TX frequency, by multicasting an original program provided through an RF channel and a program provided through another RF channel, when changing a TX frequency of another RF channel in a digital broadcasting station.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a broadcast controlling apparatus for changing a transmission TX frequency in digital broadcasting includes: a broadcast controlling unit configured to divide a data rate of a radio frequency (RF) channel, while changing a TX frequency of a second RF channel, and allocate a first program provided through the RF channel and a second program provided through the second RF channel; and a first broadcast signal transmitting unit configured to process the first and second programs through the RF channel under the control of the broadcast controlling unit and digital-broadcast the resulting programs.

The broadcast controlling unit may allocate the first and second programs in a multicast mode.

After changing the TX frequency of the second RF channel, the broadcast controlling unit may provide the first program at the original data rate of the RF channel.

The first broadcast signal transmitting unit may process the first program through the RF channel and digital-broadcast the resulting program.

The broadcast controlling apparatus may further include a second broadcast signal transmitting unit configured to process the second program through the changed RF channel and digital-broadcast the resulting program, wherein the broadcast controlling unit may provide the second program through the changed RF channel after changing the TX frequency of the second RF channel.

In accordance with another embodiment of the present invention, a broadcast controlling method for changing a TX frequency in digital broadcasting includes: a broadcast controlling operation for dividing a data rate of a radio frequency (RF) channel, while changing a TX frequency of a second RF channel, and allocating a first program provided through the RF channel and a second program provided through the second RF channel; and processing the first and second programs through the RF channel and digital-broadcasting the resulting programs.

The broadcast controlling method may further include: digital-broadcasting the first program through the RF channel at the original data rate of the RF channel after changing the TX frequency of the second RF channel; and digital-broadcasting the second program through the changed RF channel after changing the TX frequency of the second RF channel.

The broadcast controlling operation may allocate the first and second programs in a multicast mode.

### BRIEF DESCRIPTION OF THE DRAWINGS

FIGS. 1A and 1B are block diagrams illustrating a broadcast controlling apparatus for changing a TX frequency in digital broadcasting in accordance with an embodiment of the present invention.

FIG. 2A is a diagram illustrating a data rate of an RF channel A for a program A.

FIG. 2B is a diagram illustrating a data rate of an RF channel A for programs A and B.

FIG. 3 is a flow diagram illustrating a broadcast controlling method for changing a TX frequency in digital broadcasting in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Throughout the disclosure, when one element (or component) is referred to as being ‘connected’ to another element (or component), it should be understood that the former can be ‘directly connected’ to the latter, or ‘electrically connected’ to the latter through an intervening element (or component). Also, when it is described that one comprises (or includes or has) some elements, it should be understood that it may comprise (or include or have) other elements as well as those elements unless otherwise specified.

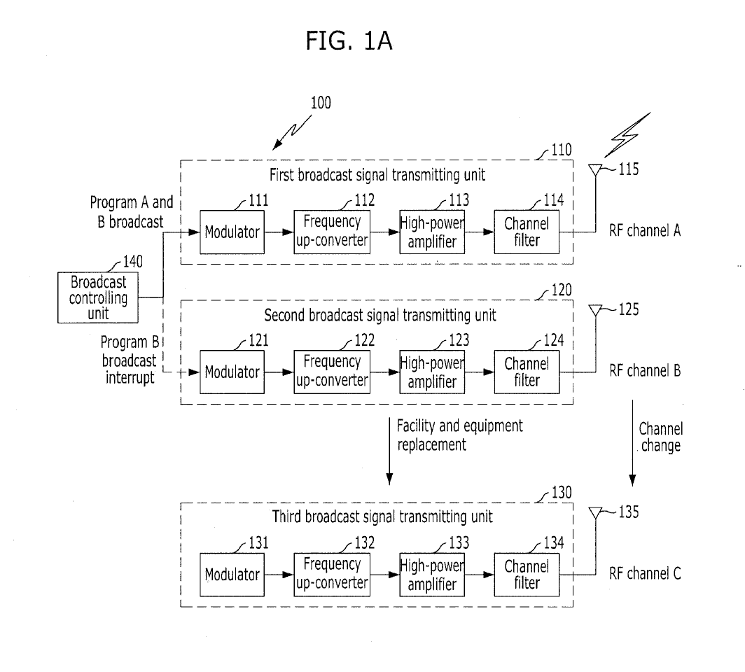

FIGS. 1A and 1B are block diagrams illustrating a broadcast controlling apparatus for changing a TX frequency in digital broadcasting in accordance with an embodiment of the present invention.

Referring to FIGS. 1A and 1B, a broadcast controlling apparatus 100 for changing a TX frequency in digital broadcasting in accordance with an embodiment of the present invention continuously provides a broadcast service (i.e., a program) allocated to a TX frequency, even when a broadcasting station operating at least two digital broadcast TX frequencies (i.e., broadcast channels) replaces equipments or facilities according to a TX frequency change, and continuously provides an original broadcast service through the changed TX frequency instead of the TX frequency after completion of the replacement of the equipments or facilities for the TX frequency.

To this end, the broadcast controlling apparatus 100 includes: broadcast signal transmitting units 110, 120 and 130 configured to process digital broadcast signals according to the corresponding TX frequencies and transmit the resulting signals; and a broadcast controlling unit 140 configured to control a TX frequency to be changed to a desired TX frequency.

Each of the first, second and third broadcast signal transmitting units 110, 120 and 130 transmits a digital broadcast signal (i.e., audio and video data) through a predetermined TX frequency.

The first broadcast signal transmitting unit 110 transmits a digital broadcast signal through a TX frequency of an RF channel A. The second broadcast signal transmitting unit 120 transmits a digital broadcast signal through a TX frequency of an RF channel B. The third broadcast signal transmitting unit 130 transmits a digital broadcast signal through a TX frequency of an RF channel C.

For convenience in description, a description will be given on an exemplary case where A program B provided by the RF channel B is provided by the RF channel C when the TX frequency of the RF channel B is changed to the TX frequency of the RF channel C after a broadcasting station has provided a digital broadcast service of a program A through the RF channel A and has provided a digital broadcast service of a program B through the RF channel B. Herein, the first broadcast signal transmitting unit 110 multicasts digital broadcast signals of the programs A and B through the TX frequency of the broadcast channel A, and the second broadcast signal transmitting unit 120 is replaced with the third broadcast signal transmitting unit 130.

Each of the broadcast signal transmitting units 110, 120 and 130 is provided for a TX frequency according to each RF channel. The broadcast signal transmitting unit 110/120/130 includes a modulator 111/121/131, a frequency up-converter 112/122/132, a high-power amplifier 113/123/133, a channel filter 114/124/134, and a TX antenna 115/125/135. The broadcast signal transmitting unit 110/120/130 transmits a digital broadcast signal, received from the broadcast controlling unit 140, through the TX antenna 115/125/135. The modulator 111/121/131 modulates an intermediate frequency (IF) signal by an 8-VSB (8 Vestigial Side Band) scheme and outputs the resulting signal to the frequency up-converter 112/122/132. The frequency up-converter 112/122/132 converts the IF signal to an RF signal and outputs the same to the high-power amplifier 113/123/133. The high-power amplifier 113/123/133 amplifies the RF signal and outputs the resulting signal to the channel filter 114/124/134. The channel filter 114/124/134 removes an out-of-band signal included in the amplified RF signal and outputs the resulting signal to the TX antenna 115/125/135. The TX antenna 115/125/135 outputs the resulting digital broadcast signal to a wireless medium. A description thereof will be omitted for conciseness.

The broadcast controlling unit 140 performs operations for continuously providing the broadcast service (i.e., the program B) of the RF channel B when replacing the second broadcast signal transmitting unit 120 with the third broadcast signal transmitting unit 130 as the TX frequency of the RF channel B is changed to the TX frequency of the RF channel C.

Herein, the broadcast controlling unit 140 simultaneously provides the program B provided through the RF channel B and the original program provided through the RF channel A allocated to the first broadcast signal transmitting unit 120. That is, the broadcast controlling unit 140 processes a plurality of programs A and B in a multicast mode with respect to a TX frequency band allocated to the RF channel A and provides the same to the first broadcast signal transmitting unit 110. Herein, the multicast mode is a multi mode service (MMS) and means that a plurality of programs are transmitted through a frequency bandwidth allocated to one RF channel.

Specifically, before the RF channel B is changed to the RF channel C, the broadcast controlling unit 140 provides the program A through the RF channel A without a data rate change and provides the program B through the RF channel B without a data rate change. Thereafter, while the RF channel B is being changed to the RF channel C (i.e., while the second broadcast signal transmitting unit 120 is being replaced with the third broadcast signal transmitting unit 130), the broadcast controlling unit 140 interrupts a broadcast service of the RF channel B and divides a data rate to allocate the programs A and B through the RF channel A. That is, the broadcast controlling unit 140 provides the programs A and B by dividing the data rate of providing only the program A. This means that the programs A and B (i.e., two digital broadcast programs with a decreased data rate) are transmitted through one RF channel A, and means that both of the programs A and B can be received through the RF channel A while a digital broadcast receiving unit (not illustrated) has received the programs A and B through the RF channels A and B.

Thereafter, after the RF channel B is changed to the RF channel C (i.e., after the second broadcast signal transmitting unit 120 is replaced with the third broadcast signal transmitting unit 130), the broadcast controlling unit 140 provides the program A at the original data rate of the RF channel A and provides the program B at the data rate of the RF channel C.

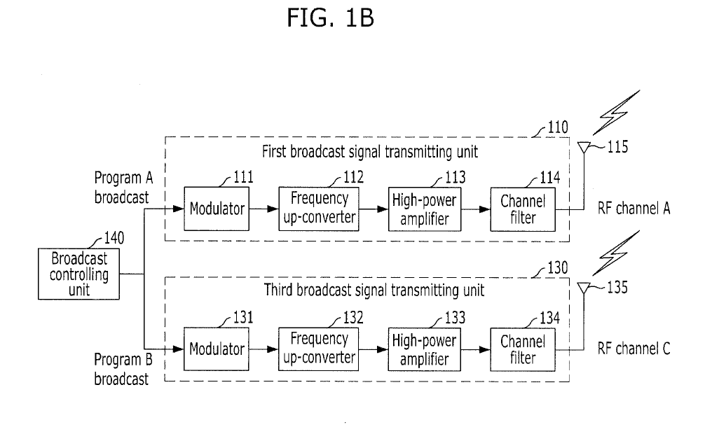

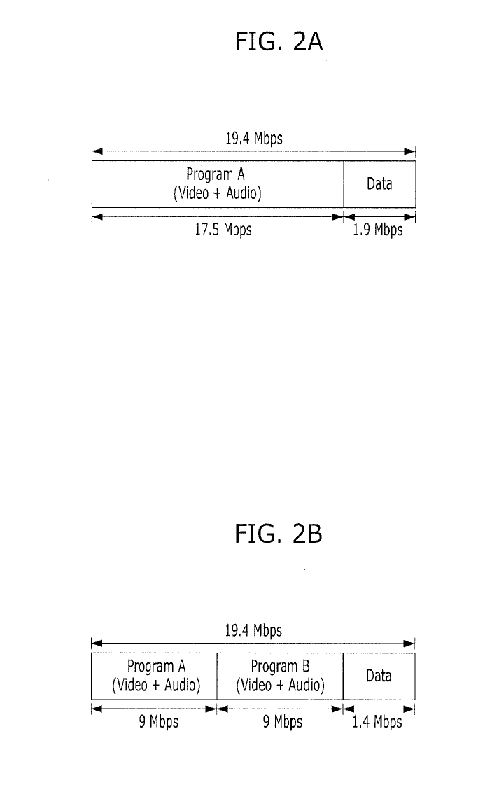

FIG. 2A is a diagram illustrating a data rate of an RF channel A for a program A, and FIG. 2B is a diagram illustrating a data rate of an RF channel A for programs A and B. Herein, it is assumed that a data rate of 19.4 Mbps is represented in a 6 MHz bandwidth of an RF channel according to an 8-VSB scheme.

Referring to FIG. 2A, the broadcast controlling unit 140 transmits one program A through one RF channel A before/after the RF channel B is changed to the RF channel C. Herein, in a 6 MHz bandwidth of one RF channel A, among the total data rate of 19.4 Mbps, the broadcast controlling unit 140 allocates a data rate of 17.5 Mbps for video/audio transmission of the program A (i.e., digital broadcast data) and allocates a date rate of 1.9 Mbps for transmission of other data.

Referring to FIG. 2B, the broadcast controlling unit 140 transmits two programs A and B through one RF channel while the RF channel B is being changed to the RF channel C. Herein, in a 6 MHz bandwidth of one RF channel A, among the total data rate of 19.4 Mbps, the broadcast controlling unit 140 allocates a data rate of 9 Mbps for video/audio transmission of each of the programs A and B (i.e., digital broadcast data) and allocates a date rate of 1.4 Mbps for transmission of other data.

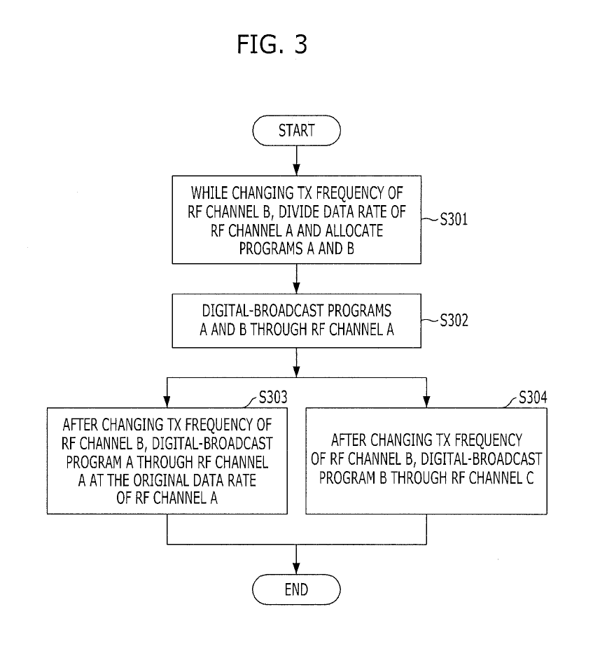

FIG. 3 is a flow diagram illustrating a broadcast controlling method for changing a TX frequency in digital broadcasting in accordance with an embodiment of the present invention.

Referring to FIG. 3, while changing the TX frequency of the RF channel B, the broadcast controlling unit 140 divides a data rate of the RF channel A and then allocates the program A provided through the RF channel A and the program B provided through the RF channel B (S301). Herein, the first broadcast signal transmitting unit 110 processes the program A through the RF channel A and digital-broadcasts the resulting signal (S302).

After changing the TX frequency of the RF channel B, the broadcast controlling unit 140 provides the program A at the original data rate of the RF channel A and the first broadcast signal transmitting unit 110 performs a digital broadcast operation through the RF channel A (S303). Also, the broadcast controlling unit 140 provides the program B through the RF channel C (changed from the RF channel B) and the third broadcast signal transmitting unit 130 perform a digital broadcast operation through the RF channel C (S304).

As described above, the present invention can continuously provide a broadcast service (i.e., a program) allocated to a TX frequency according to a TX frequency change of an RF channel and can continuously provide a broadcast service through a changed TX frequency.

Also, the present invention makes it possible to replace facilities and equipments without interruption of a broadcast service, due to a TX frequency change, when switching analog broadcast to digital broadcast in an overall manner.

While the present invention has been described with respect to the specific embodiments, it will be apparent to those skilled in the art that various changes and modifications may be made without departing from the spirit and scope of the invention as defined in the following claims.

What is claimed is:

1. A broadcast controlling apparatus for changing a transmission (TX) frequency in digital broadcasting, comprising:
a broadcast controlling unit configured to divide a data rate of a radio frequency (RF) channel, while changing a TX frequency of a second RF channel, and allocate a first program provided through the RF channel and a second program provided through the second RF channel; and
a first broadcast signal transmitting unit configured to process the first and second programs through the RF channel under the control of the broadcast controlling unit and digital-broadcast the resulting programs.

2. The broadcast controlling apparatus of claim 1, wherein the broadcast controlling unit allocates the first and second programs in a multicast mode.

3. The broadcast controlling apparatus of claim 2, wherein after changing the TX frequency of the second RF channel, the broadcast controlling unit provides the first program at the original data rate of the RF channel.

4. The broadcast controlling apparatus of claim 3, wherein the first broadcast signal transmitting unit processes the first program through the RF channel and digital-broadcasts the resulting program.

5. The broadcast controlling apparatus of claim 1, further comprising a second broadcast signal transmitting unit configured to process the second program through the changed RF channel and digital-broadcast the resulting program,
wherein the broadcast controlling unit provides the second program through the changed RF channel after changing the TX frequency of the second RF channel.

6. A broadcast controlling method for changing a transmission (TX) frequency in digital broadcasting, comprising:
a broadcast controlling operation for dividing a data rate of a radio frequency (RF) channel, while changing a TX frequency of a second RF channel, and allocating a first program provided through the RF channel and a second program provided through the second RF channel; and
processing the first and second programs through the RF channel and digital-broadcasting the resulting programs.

7. The broadcast controlling method of claim 6 further comprising:
digital-broadcasting the first program through the RF channel at the original data rate of the RF channel after changing the TX frequency of the second RF channel; and
digital-broadcasting the second program through the changed RF channel after changing the TX frequency of the second RF channel.

8. The broadcast controlling method of claim 6, wherein the broadcast controlling operation allocates the first and second programs in a multicast mode.
